(19) United States
(12) Patent Application Publication
(10) Pub. No.: US 2010/0119282 A1
(43) Pub. Date: May 13, 2010

(54) System and Method for Printing and Cutting

(75) Inventors: Donald B. Olsen, Springville, UT (US); Matthew B. Strong, Pleasant Grove, UT (US)

Correspondence Address: HONIGMAN MILLER SCHWARTZ & COHN LLP, 38500 WOODWARD AVENUE, SUITE 100, BLOOMFIELD HILLS, MI, 48304-5048, US

(73) Assignee: Provo Craft and Novelty, Inc., Spanish Fork, UT (US)

(21) Appl. No.: 12/504,651

(22) Filed: Jul. 16, 2009

Related U.S. Application Data
(60) Provisional application No. 61/081,208, filed on Jul. 16, 2008.

(51) Int. Cl. B41J 11/00; G06K 9/48

(52) U.S. Cl. 400/621; 382/199

(57) ABSTRACT

A system for printing and cutting including a housing. A printing system is connected to the housing. The printing system including a print head having a bottom surface. A cutting system is connected to said housing. A movable floor is connected to said housing where the movable floor adjusts to the thickness of a stock to be printed. The movable floor providing a predetermined distance from the bottom surface of the print head and the upper surface of the stock.

### CROSS REFERENCE TO RELATED APPLICATION

This application is based on, and claims priority under 35 U.S.C. §119(e) to U.S. Provisional Patent Application No. 61/081,208 filed on Jul. 16, 2008, titled “System and Method for Printing and Cutting”, to Donald B. Olsen et al., and which is incorporated herein by reference in its entirety.

### FIELD OF THE INVENTION

The disclosure relates to a system and method for printing and cutting.

### BACKGROUND

Arts and crafts projects may be improved with colorful cutouts and shapes. The stock may be paper, vellum, thin plastics, foils, transparencies, card stock, etc. The stock may be generally used for shapes and scenes desired by the user. The stock may be pre-colored, or the user may further embellish the stock after cutting. Typical systems for creating shapes from paper include die cutting and electronic die cutting. These systems create predetermined shapes, typically in paper. However, the user must select the color of paper prior to performing the cutting. Moreover, to create complex designs the user may need to change paper colors frequently.

Small and economical inkjet printers are known in the market, but they are not useful with respect to cutting out shapes because the printed image is not in registration with the cutting system. This typically means that alignment will not be correct and a cut shape from a printed image will be ruined, requiring another attempt by the user.

Moreover, the precision for aligning the printed image with the cutting system may be inaccurate and cause numerous re-prints before a useable cutout is made. Thus, the need exists for a system that allows the user to print an image and cut the image without manual registration.

### BRIEF DESCRIPTION OF THE DRAWINGS

The disclosure will now be described, by way of example, with reference to the accompanying drawings, in which:

FIG. 1 is a perspective view of an apparatus for printing and cutting.

FIG. 2A is a method for continuous ink printing while a print head is in motion.

FIG. 2B is a method for applying heavy ink to a pixel element.

FIG. 3 is a method to merge multiple images together.

FIG. 4 is a method of printing and/or cutting.

FIG. 5 is a method of determining space requirements after user-manual alignment.

FIG. 6 is a method of performing border cutting to an arbitrary image or shape.

FIG. 6A is an example of an image having an outer boundary.

FIG. 6B is an example of an image having an outer boundary and a border extending from the outer boundary.

FIG. 7 is a method of printing an image in black & white, grayscale, and color, as a standalone machine.

FIG. 7A is an example of printing multiple images to a sheet of stock.

FIG. 8 is a method of tiling an image.

FIG. 8A shows an image printed and cut at boundary from a plurality of sheets.

FIG. 8B shows a key image.

FIG. 9 is a method to determine the number of ink cartridges used, and provide warnings to the user.

FIG. 10 is a system diagram of a combined stepper motor and DC motor driver for the cutting and printing system.

FIG. 10A is a perspective view of an example mechanism for printing and cutting.

FIG. 10B is a front view of the example of FIG. 10A showing the cutting mechanism and roller system.

FIG. 10C is a back view of the example of FIG. 10A showing the printing mechanism.

FIG. 10D is a right side view of the example of FIG. 10A.

FIG. 10E is a left side view of the example of FIG. 10A.

FIG. 10F is a top view of the example of FIG. 10A.

FIG. 10G is a bottom view of the example of FIG. 10A.

FIG. 10H is a perspective view of the example of FIG. 10A.

FIG. 10I is a perspective cutaway view of the example of FIG. 10A.

FIG. 10J is aside cutaway view of the example of FIG. 10A.

FIG. 10K includes views of a roller system for engaging a mat for the example of FIG. 10A.

FIG. 11 is an example of a floating roller system that accepts thick material stock.

FIG. 12 is a method for cutting three-dimensional shapes.

FIG. 12A shows a layered 3-D image in cross section of a pyramid.

FIG. 13 is a method of user-defined cutting of a shape.

### DETAILED DESCRIPTION

The Figures illustrate an exemplary embodiment of a system and method for printing and cutting. Based on the foregoing, it is to be generally understood that the nomenclature used herein is simply for convenience and the terms used to describe examples of the system and method and should be given the broadest meaning by one of ordinary skill in the art. This application is based on, and claims priority under 35 U.S.C. §119(e) to U.S. Provisional Patent Application No. 61/081,208 filed on Jul. 16, 2008, titled “System and Method for Printing and Cutting”, to Donald B. Olsen et al., and which is incorporated herein by reference in its entirety.

The system and method for printing and cutting may be, in an example, configured as printing system combined with a cutting system for use in the craft industry, among others. An example of a cutting system is described in U.S. patent application Ser. No. 11/457,417, to Workman et al., filed Jul. 13, 2006, and entitled “ELECTRONIC PAPER CUTTING APPARATUS AND METHOD”, the entirety of which is incorporated by reference herein.

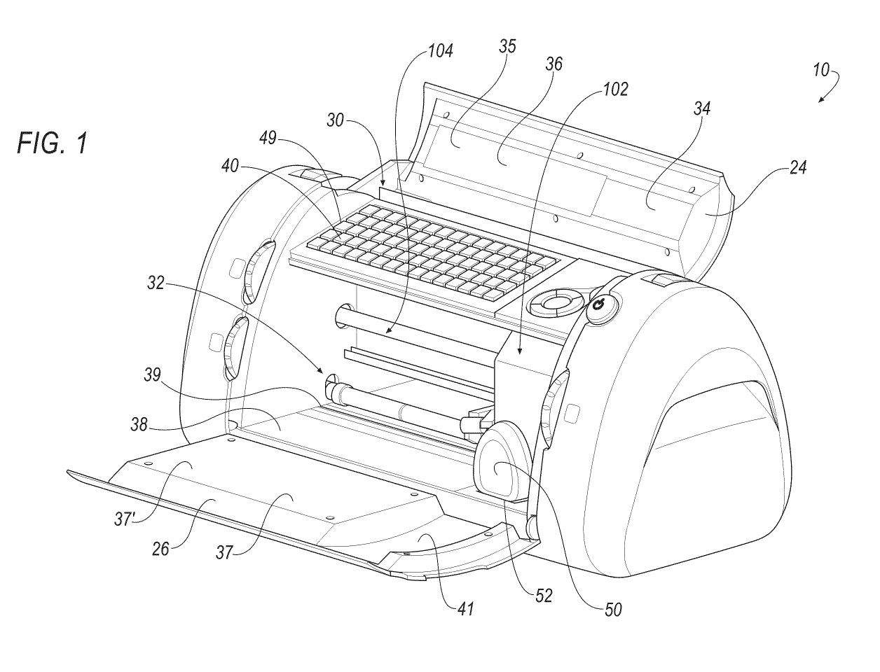

Referring now to FIG. 1, a printer/cutter 10 is illustrated with printing and cutting mechanisms 102 being movable along a guide 104. As will be known to those of skill in the art, a printing system such as an inkjet printing system may be used to deposit ink on paper or other materials to perform the printing function. Printer/cutter 10 is illustrated in an open position in which the user interface, generally indicated at 30, and cutter assembly, generally indicated at 32, are shown. The back surface 34 of the top door 24 houses a visual display 35, such as an LCD display. Certain relevant data, such as the shape or shapes selected for being cut, the size of the shape, the status of the progress of a particular cut, error messages, etc. can be displayed on the display 35 so that the user can have visual feedback of the operation of the machine.

The back surface 37 of the bottom door 26 provides a support tray for the mat and material being cut by the printer/cutter 10 so that the material and mat (not shown) remain in a substantially horizontal orientation when being cut. In addition, the inner bottom surfaces 38 of the cutter are also generally horizontal and planar in nature to support the material being cut in a substantially flat configuration. In some prior art machines that have been adapted from the vinyl sign cutting field to the paper cutting field, the machines have generally retained a curved support surface. The curvature of the support surface was generally employed to accommodate the material being cut, namely adhesive backed vinyl, typically in a roll form. Such a configuration is not particularly conducive to cutting sheets of material such as paper and the like where bending can cause portions of the images being cut to lift from the planar surface defined by the sheet causing the blade or blade holder to catch any such raised portions that could damage the material of the shape being cut. The inner surface 37 of the door 26 thus includes a planar surface portion 37′ that is substantially coplanar with the inner bottom surface or bed 38 of the cutter adjacent the drive roller 39. In addition, the inner surface 37 defines a recess 41 for accommodating the cartridge 50 when the door 26 is in a closed position as shown in FIG. 1. This allows for a more compact configuration of the printer/cutter 10 with the cartridge 50 fitting within the door 26. Thus, the machine can be transported with the cartridge 50 positioned inside with the door 26 closed.

The printer/cutter 10 includes a memory storage device 50 for storing various shapes and images, such as fonts, images, phrases, etc., that can be printed and cut by the printer/cutter 10. Memory storage device 50 may also include storage of different printing and cutting parameters such as the resolution of the image, the registration points for the image and the cutting boundaries, the tolerances required for printing and cutting at various sizes, etc. In this embodiment, the memory storage device 50 is in the form of a removable and replaceable cartridge. The cartridge is provided with a particular library or set of shapes that can be selected using the keyboard 40. When a new set of shapes is desired, the cartridge 50 can be removed form its socket 52 and replaced with another cartridge containing the desired shape or shapes. In combination with a change of the cartridge 50, the keyboard 40 is provided with a removable and replaceable overlay 49 that is formed of a flexible material such as silicon rubber, PVC or other rubber-type materials to allow the keys of the keyboard 40 to be pressed when the corresponding raised keys of the overlay are pressed. The overlay may be formed from a clear, transparent or translucent material to allow light from the keys of the keyboard 40 to be seen through the overlay 49. In order to identify which overlay corresponds to a particular cartridge, the particular name of the font or image set (as well as the individual characters, phrases and functions) can be printed, as by silk screening or other methods, onto the overlay and the same name printed on the cartridge or printed on a label that is attached to the cartridge. Also, if desired, by matching the color of a particular keyboard overlay 49 with the color of a particular cartridge 50, a user can easily verify that they are using the correct cartridge 50/overlay 49 combination. For any given color or material from which the overlay is formed, the overlay is not completely opaque. Thus, as previously discussed, in order to signify to the user that a particular function key has been activated, such as CAPS or the like, an LED is positioned beneath the key to illuminate the key when activated. As such, by forming the overlay 49 from material that is at least partially translucent, the light from the LED is visible to the user through the overlay 49. Thus, both the keys of the keyboard and the overlay 49 are formed from an at least semi-translucent material.

An alternative to the keypad and overlay 49 may include a LCD touch screen capable of rendering the font or image set. To select a particular shape, the user may push on the shape directly as it is shown on the LCD touch screen and the system recognizes a selection from the touch screen.

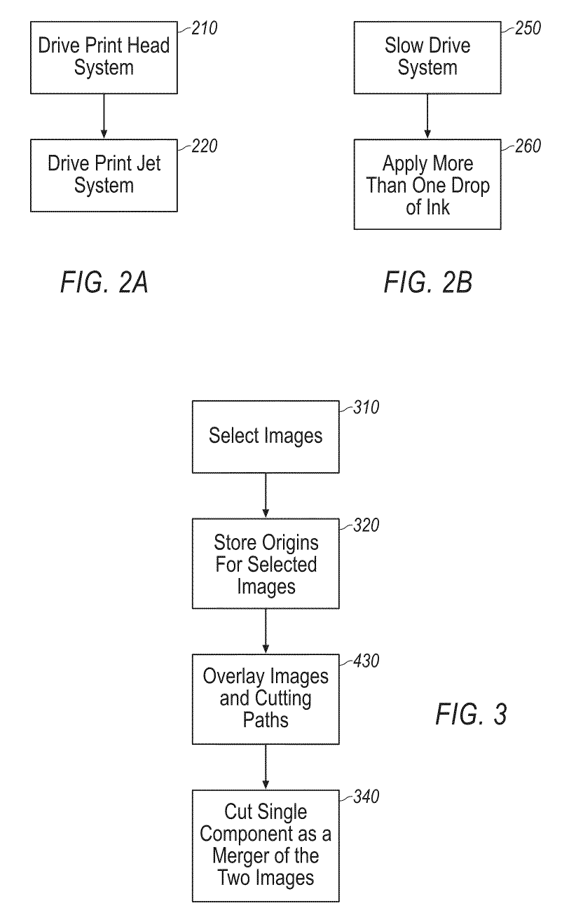

FIG. 2A is a method for continuous ink printing while a print head is in motion (see step 210). In some examples (e.g., where a flat field is desired) or regions of color are the same color, printer/cutter 10 may employ a continuous printing method deposit a stream of ink (see step 220) on the stock (e.g., paper). Instead of printing dots, printer/cutter 10 has printed a stream of color.

FIG. 2B is a method for applying heavy ink to a pixel element. Printer/cutter 10 may apply “heavy ink” to a particular area. For example, where heavy ink is required, printer/cutter may apply more than one drop of ink to that location. For example, at an area required to be rich with a particular color, printer/cutter 10 may slow or stop movement (see step 250) apply more than one droplet of ink (see step 260) to that location. At step 260, the printing system may apply more than one droplet of ink to a particular location. This may be done on multiple passes, or this may be done if the printing system stops at a particular location, or this may be done by rapidly jetting ink at the location when the printing system is slow driving the print head.

FIG. 3 is a method to merge multiple images together (e.g., “welding” or “stringing” images together) to create a single image from many. In step 310 the user selects the images to be welded. In step 320, printer/cutter 10 stores the origin offsets for locating each image may be stored within a larger data structure, the data structure holding each image's data for graphics and cutting. In step 330, printer/cutter 10 decides how to overlay the images so that the images are welded together and are not cut individually. Such welding may include not cutting the portions that overlap, or where there are non-overlapping images, to insert a place-holder bridge between the image portions to hold them in registration with each other after printing and cutting are complete. In step 340, the images are cut from the same stock as a single piece.

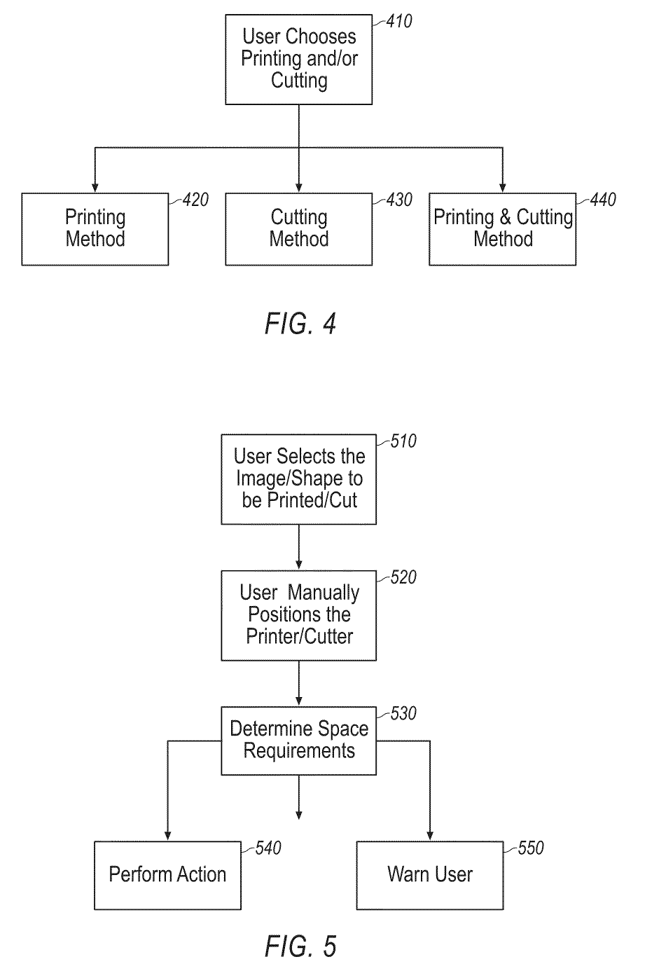

FIG. 4 is a method of printing or cutting, or printing and cutting. Printer/cutter 10 may be used for both printing and/or cutting. Thus, the user need not purchase separate machines to perform each function individually, or they may perform both functions with the same machine. User interface 30 may be used to determine the mode of operation for printer/cutter 10. For example, the user may select an image or shape to be cut, and they may further select the mode of operation for printer/cutter 10 as only printing, only cutting, or printing and cutting. In this way, printer/cutter 10 alters the functionality accordingly. At step 410, the user inputs the printing/cutting mode. If the user chooses printing only, control transfers to the printing method at step 420. If the user chooses cutting only, control transfers to the cutting method at step 430. If the user chooses printing and cutting, control transfers to the print and cut method at step 440. In step 420, the printing method reads the printing-related data from memory storage device 50 and begins a printing operation. In step 430, the cutting method reads the cutting-related data from memory storage device 50 and begins a cutting operation. At step 440, the print and cut method reads both the printing-related data and cutting-related data from memory storage device 50 and begins printing, and afterwards the cutting is performed.

FIG. 5 is a method of determining space requirements after user-manual alignment.

At step 510, the user selects the image to be printed and/or the shape to be cut, along with parameters such as size, scaling, or feature addition (e.g., skew, addition of a background, etc.).

At step 520, the user manually positions the printer/cutter head system for the starting position on the page. Positioning of the head system may be done using arrow keys on user interface 39, or by manual movement of the print/cut head (wherein a feedback system allows printer/cutter 10 to determine the absolute position of the head).

At step 530, the printer/cutter 10 determines the space requirements to print and/or cut an image or shape based on the “zero” position of the head system after manual alignment by the user. Printer/cutter 10 may use the size of a new sheet of print/cut stock, or use stored information about the regions of the print/cut stock that has already been used, to determine the space requirements needed for performing the user's requested action. If there is enough area to perform the action, control proceeds to step 540 where the operation is performed. If there is not enough are to perform the requested action, control proceeds to step 550 where the user is warned that not enough area is present. Printer/cutter 10 may then query the user to determine if they would like to scale the print/cut image/shape to a lesser size to fit the available area.

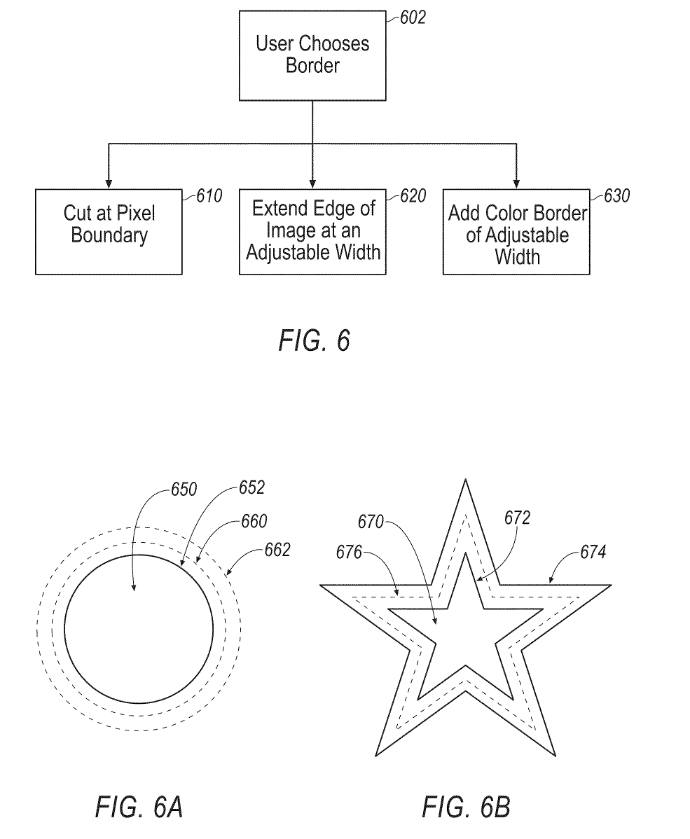

FIG. 6 is a method of performing border cutting to an arbitrary image or shape. The border may be the addition of a background color to the image beyond or at the cutting boundary, an extension of the colors of the image at the border, or an image filter applied to the edge of the image to provide an interesting border color. In step 602, the user selects the border mode. In step 610, no border is selected and the image may be cut at the pixel boundary of the image.

At step 620, an edge extension mode is selected and the printer/cutter 10 extends the pixels bordering the image to provide a crisp line when cut. The border selected may be of an adjustable width (generally shown in FIG. 6A). The printer/cutter may also add a national width to the border to provide that no “white space” remains when the cut is performed (generally shown in FIG. 6B).

At step 630, a color border is selected and for example, a black border (or any other color), may be added as a fill to the surrounding portions of the image to provide a black edge or key-line effect. The border selected may be of an adjustable width. The printer/cutter may also add an additional width to the border to provide that no “white space” remains when the cut is performed (generally shown in FIG. 6B).

FIG. 6A is an example of an image 650 having an outer boundary 652. The user may select to have a border placed around the image boundary 652, the border being of various widths. In a first example, the border is selected by the user to be an arbitrary width 660. If the user desires, the border may be selected as a larger arbitrary with 662. The printer/cutter 10 may also automatically select the border width depending upon the resolution of the printing system and cutting system to maximize the smoothness and clarity of the image when cut. The extension of an outer boundary may also provide a margin of error where the cutting system is not perfectly registered with the printed image. For example, where there is an inaccuracy in the cutting locations, with respect to the printed image, the extended boundary allows for a clean cut through the colored boundary without “white” area being left after cutting. This “white” area need not be white in color, but rather, indicates the color of the media being printed upon, which may be substantially white in color.

The border may be determined, for example, by a user input (e.g., through a user interface such as a keypad, a thumbwheel, a touch screen, etc.). An example may be the user indicating that a 0.2″ boundary is desired. In this case, the system extends the border by 0.2″ around the outer boundary 652. Alternatively, the border may be determined by extending the outer boundary 652 by a predetermined amount. For example, where the precision of the cutting system is known to be at about 0.05″, the border may extend the outer boundary by about 0.10″ to provide a margin of safety depending on the working condition of the print and cut system (e.g., the age of the apparatus) or the type of work piece being cut. Alternatively, the outer boundary 652 may be scaled up a predetermined distance to determine the border thickness.

FIG. 6B is an example of an image 670 having an outer boundary 672, and a border 674 extending from outer boundary 672. When the user selects a boundary width (represented by dashed line 676), printer/cutter 10 may add an additional thickness to the border and extend the border to border line 674. The automatic addition of border width allows printer/cutter 10 to cut the image at cut line 676 while allowing for no white space being present in the cut image. By extending the border beyond cut line 676, the cut image is guaranteed to have a full color border. As discussed above, the extension of the colored border handles situations where the cutting path is reasonably out of registration, or when the cutting tool may not be able to perfectly change direction or cut an arc-path with sufficient precision.

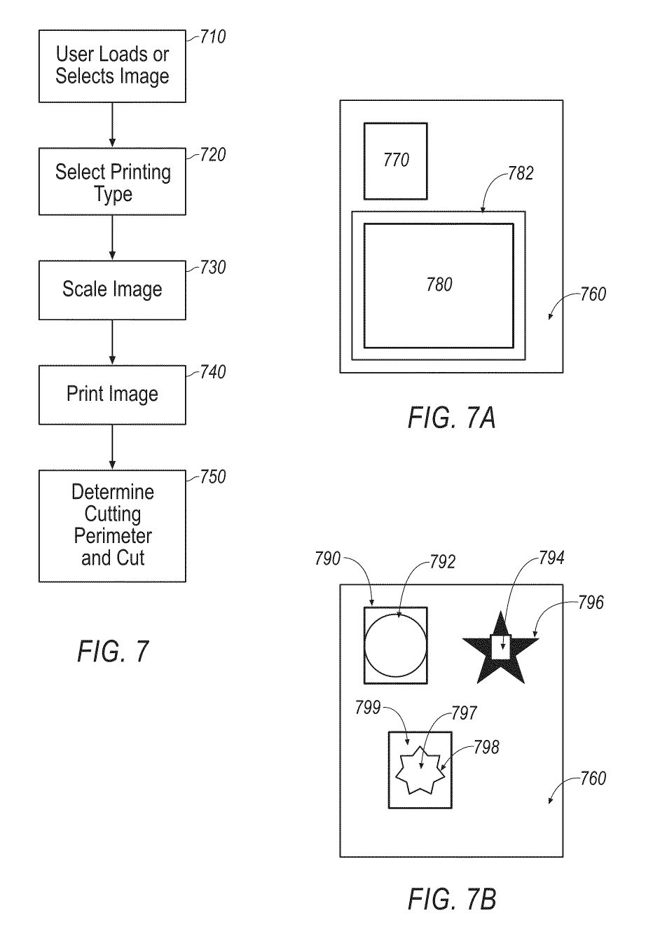

FIG. 7 is a method of printing an image in black & white, grayscale, and color, as a standalone machine. The user may load an image from cartridge 50 or other memory at step 710. At step 720, the user may select the printing type (e.g., color, black & white, grayscale, etc.) or add additional features such as sepia before printing. The user may then scale the image at step 730 to the particular size desired. At step 740, printer/cutter 10 then prints the image in the desired format and size. At step 750, printer/cutter 10 may calculate the cutting perimeter (if any) based on the size of the print, allowing the user to print custom-sized photos that are cut from the stock material (e.g., photo-paper) at the size of the print. Using the methods of FIG. 6, the user may also add “frame” borders or other features such as scalloping, or shadowed borders to give the image depth.

The printed image and cutting path may be rasterized or vector based. Moreover, the image and cutting path may be contained in a cartridge or storage device together. When scaling the image and cutting path, the system may automatically modify the image and cutting path to scale up the image. Alternatively, the image and cutting path may be stored as a sufficiently large image and cutting path so that all or substantially all of the scaling is a downward scaling to reduce rasterization and pixelization effects. Moreover, where the image and cutting paths are scaled downwardly, some detail may be reduced to suit the particular resolution of the print system, as well as the precision of the cutting system. Thus, the reduction in detail may be different for the image and the cutting path based on their particular capabilities.

FIG. 7A is an example of printing multiple images to a sheet of stock 760 (e.g. photo-paper) where the user selects the size of the image, and the image is cut-to-size. A first image 770 is printed and cut to size. A second image 780 is printed and a border 782 is added, the image is then cut to size at the border perimeter at 782. In an example the user could cut multiple images from a single sheet of stock, each image being of different size, or the same size, but being cut free from stock at the edge of the image. Such system then no longer requires the user to purchase multiple sizes of stock, but also does not require them to manually cut the image to size.

FIG. 7B is an example of printing various sized images with various borders and cutting paths. For example, an image 790 is provided where a cutting path 792 is positioned over a portion of image 790 to selectively cut out a region. In an alternative example, the image not circumscribed by cutting path 792 is not printed on stock 760. In another example, a cutting path 796 is shaped like a star and an image 794 is placed within cutting path 796. Printer/cutter 10 may fill the area not occupied by image 794 with a color (shown by the black portion) as an aesthetic detail. In another example, a scalloped edge 798 is made within the boundaries of image 799 leaving a scalloped image portion 797. The user may select the boundary from the user interface 30 and printer/cutter 10 may apply the boundary to the image 799, and maximize the size of the cutting path 797. In an alternative example, the user may be displayed the image 799 on a graphical display and the user may then position the cutting path 797 on the image arbitrarily.

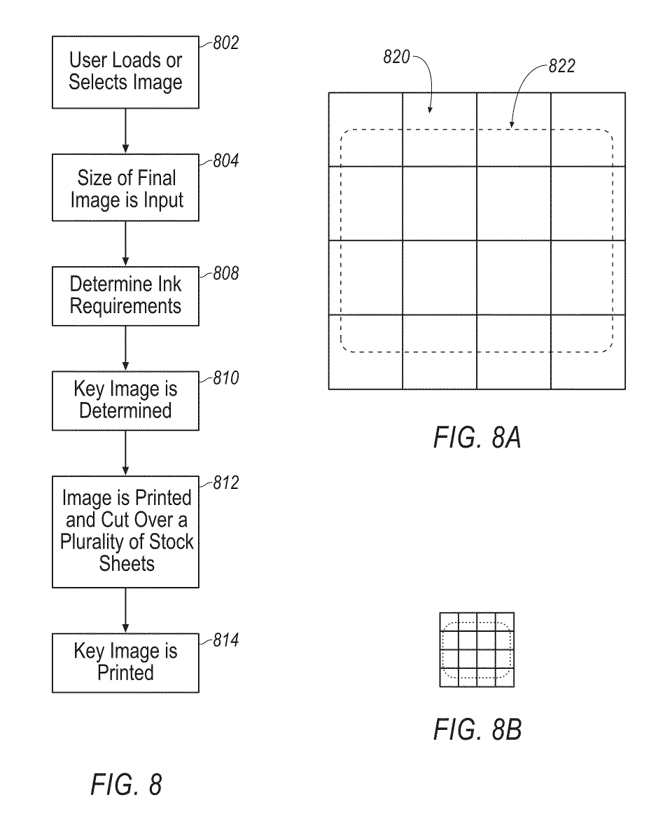

FIG. 8 is a method of tiling an image and cutting paths. A large image may be printed across a plurality of pieces of stock (e.g., paper) and may be assembled by the user into a larger image. In step 802, the user selects an image. In step 804, the size of the final image is input by the user (e.g., 5 feet across). At an optional step 808, printer/cutter 10 may estimate the ink usage for printing the image across the plurality of sheet, and may also include the key image in the calculation. Printer/cutter 10 may then warn the user if not enough ink is present based on estimates of consumption, or feedback from the printing system. The warning may be a general warning for multi-color systems, or it may warn that a specific color may be low such that the user can replenish only that color which may not last during the printing process. At step 810, printer/cutter 10 determines how to print and cut the image across the plurality of pieces of stock (see FIG. 8A) and creates a key image (see FIG. 8B). The key image may further include a numbering system for the user to identify where each sheet is located relative to the other sheets. A number may be added to each image portion cut in anon-obvious manner (e.g., by color-shifting or small black printing) so that the user can identify the sheet in relation to the key image. At step 812, printer/cutter 10 manufactures the image from multiple pieces of stock, cutting the border if desired. At step 814, the key image is printed on a separate sheet of stock, or may be printed on an unused area (waste) during step 812 to conserve stock. During printing, if a tile (a sheet of the larger image) is defective or the printing/cutting is not completed satisfactorily, the user may redo a tile, or may start from a certain tile and continue the process. FIG. 8A shows an image printed and cut at boundary 822 from a plurality of sheets 820. FIG. 8B shows a key image, which is a small version of the large scale image, that allows the user to identify each sheet of the image for placement. The key image is useful where each of the tiles may be in random arrangement, and the user must decide on the adjacencies of the placement. Thus, the key image substantially functions as a puzzle key image to direct assembly of each tile. The key image may be printed on a separate sheet, or it may be printed on a scrap area of the cut sheets that comprise the tiles.

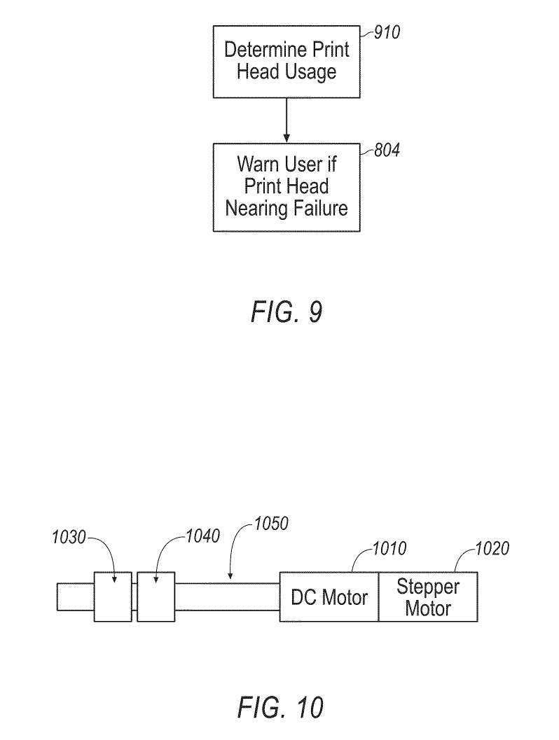

FIG. 9 is a method to determine the number of ink cartridges used, and provide warnings to the user. In step 910, printer/cutter determines the usage rate of the print head by the number of ink droplets used since the last print head change. This information may be stored in the memory of printer/cutter 10 or it may be stored in the print head itself. At step 920, printer cutter warns the user to replace the print head if a new print head is desired. The system may also determine that the heads should be changed for quality and/or contamination issues based on the amount of ink used. If, for example, significant cutting is performed by the user but less printing, then the system may determine that a print head change should be performed based on the expected amount of contamination from paper dust etc.

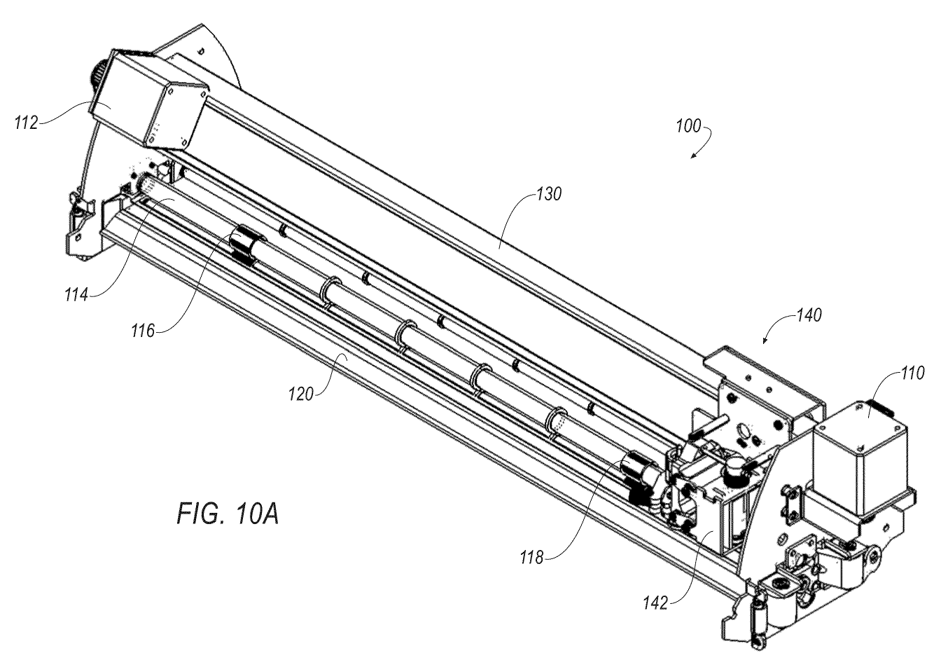

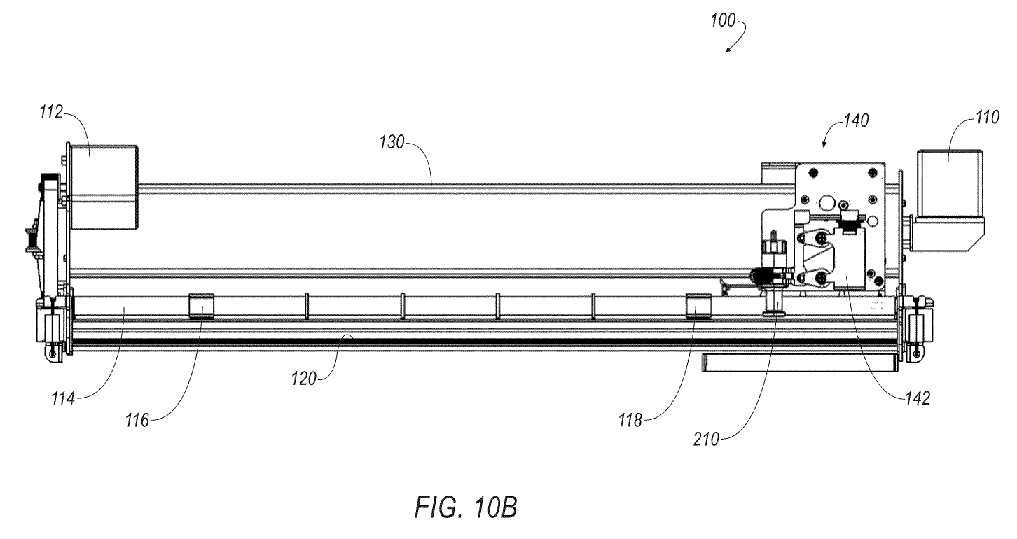

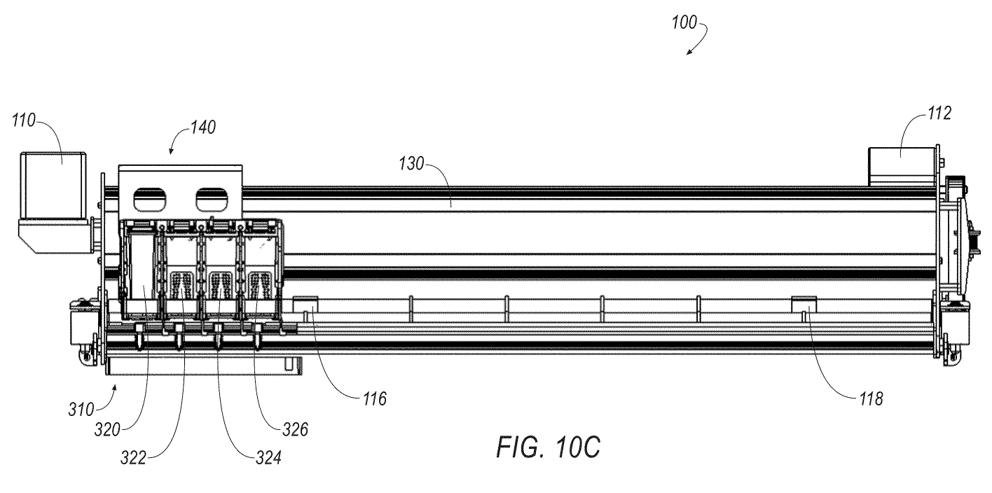

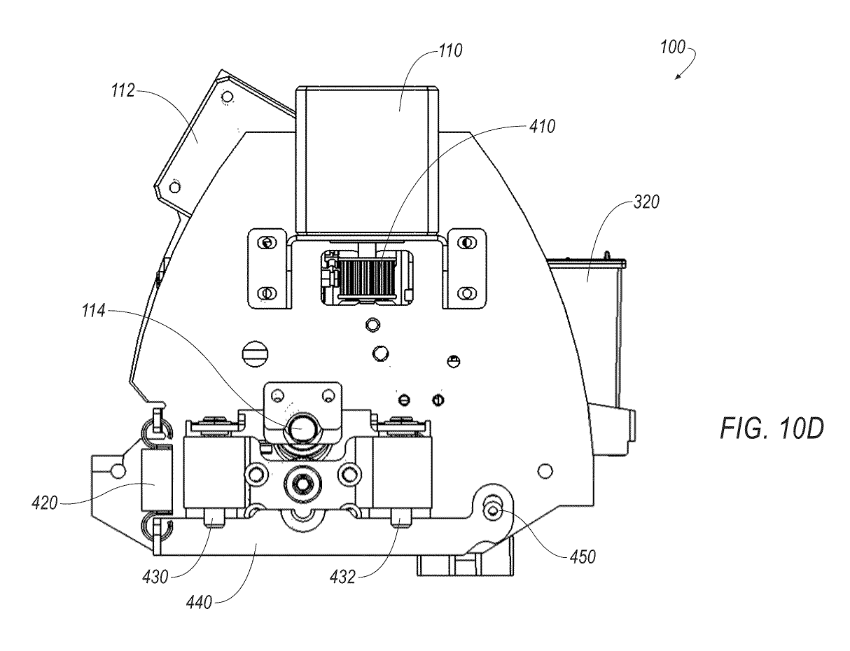

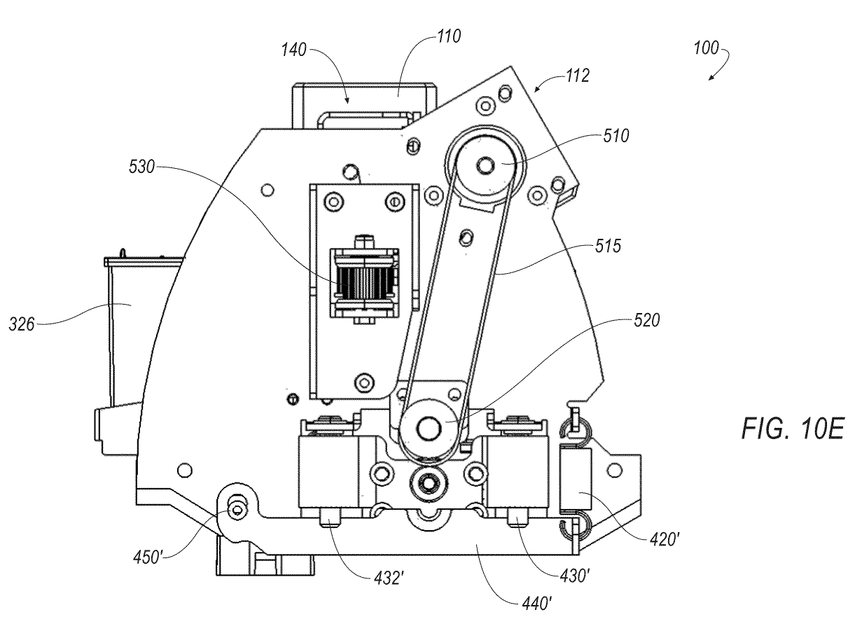

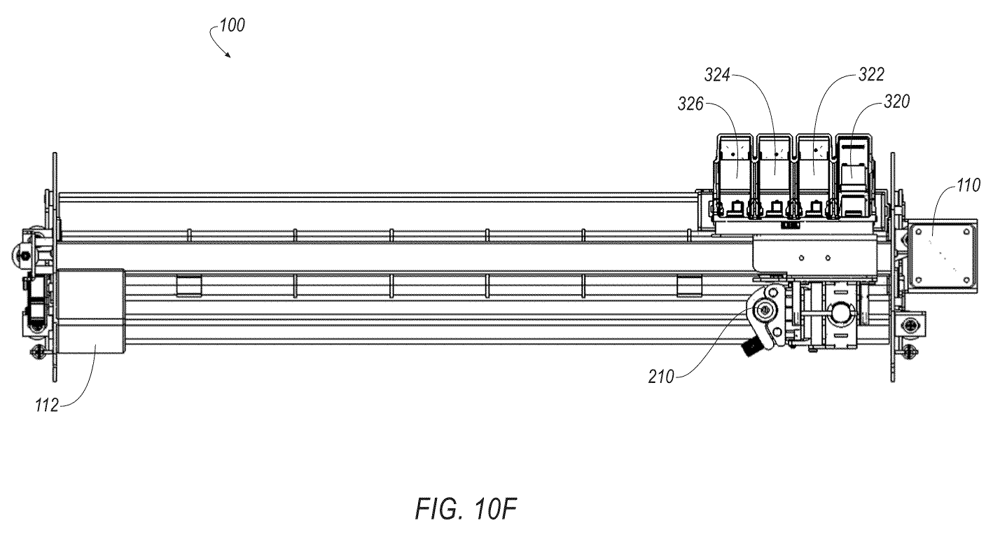

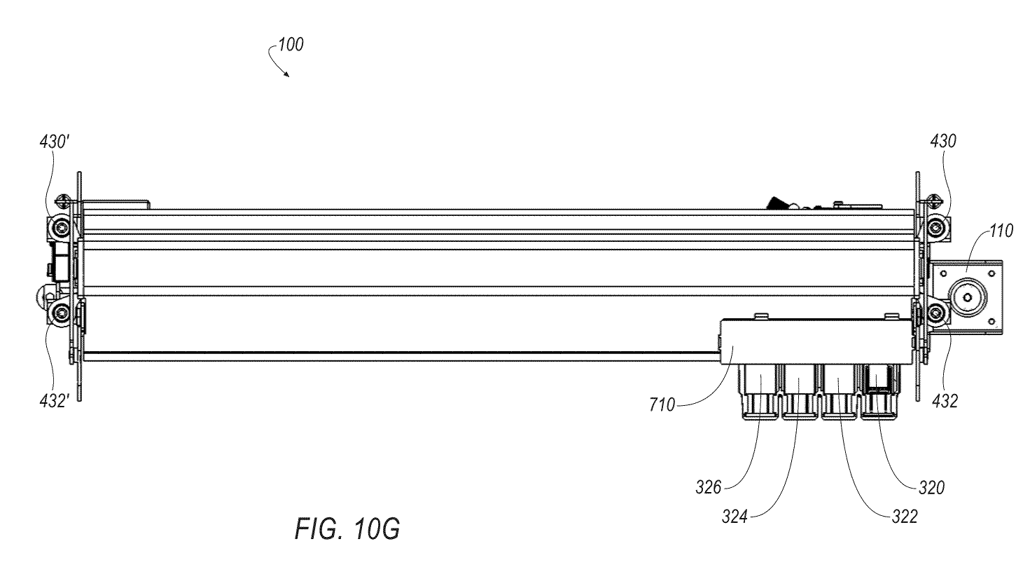

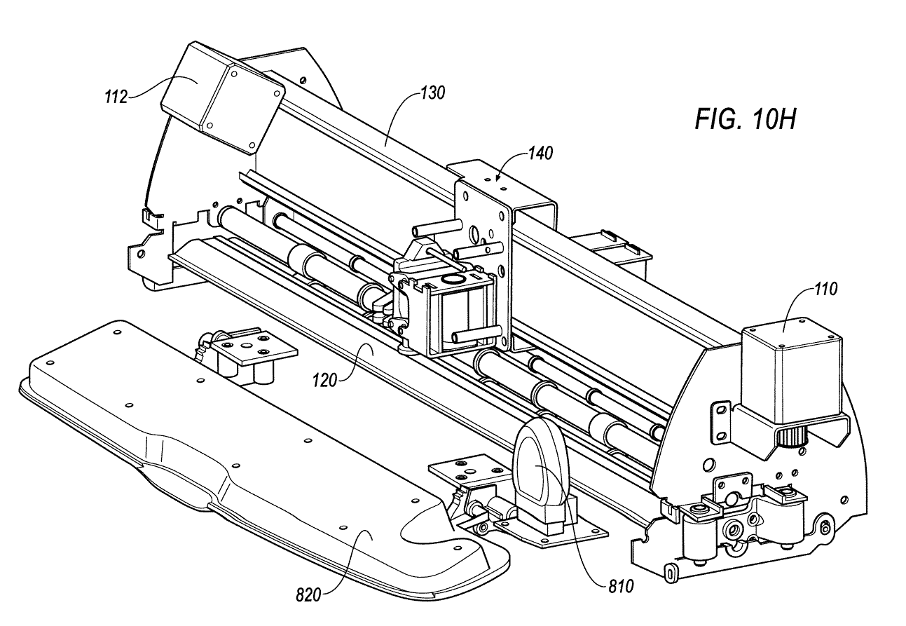

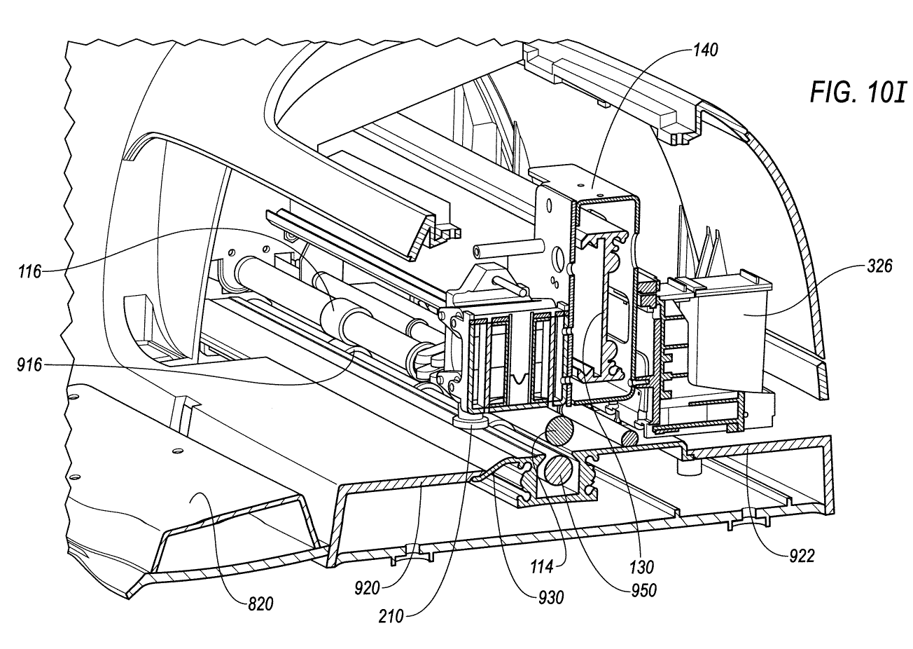

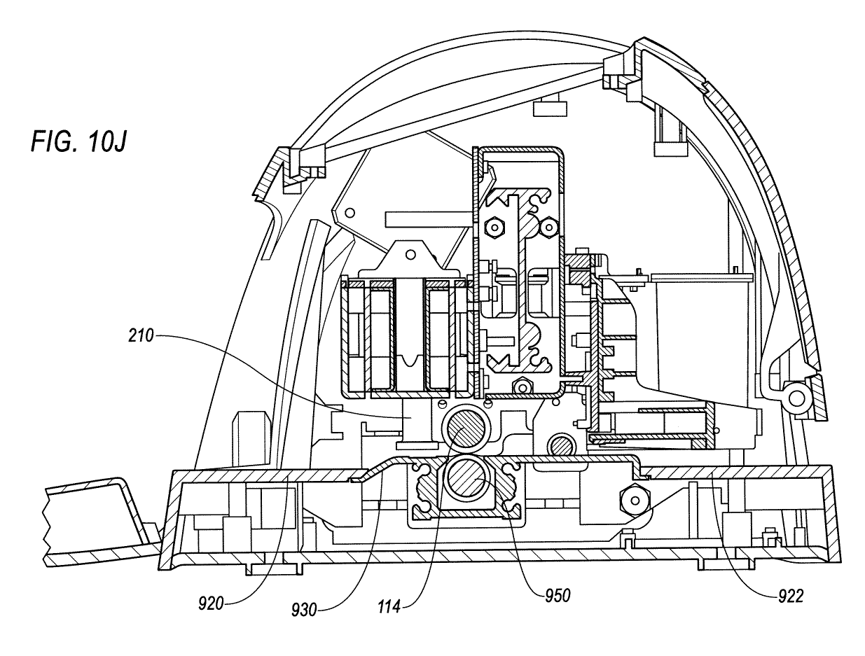

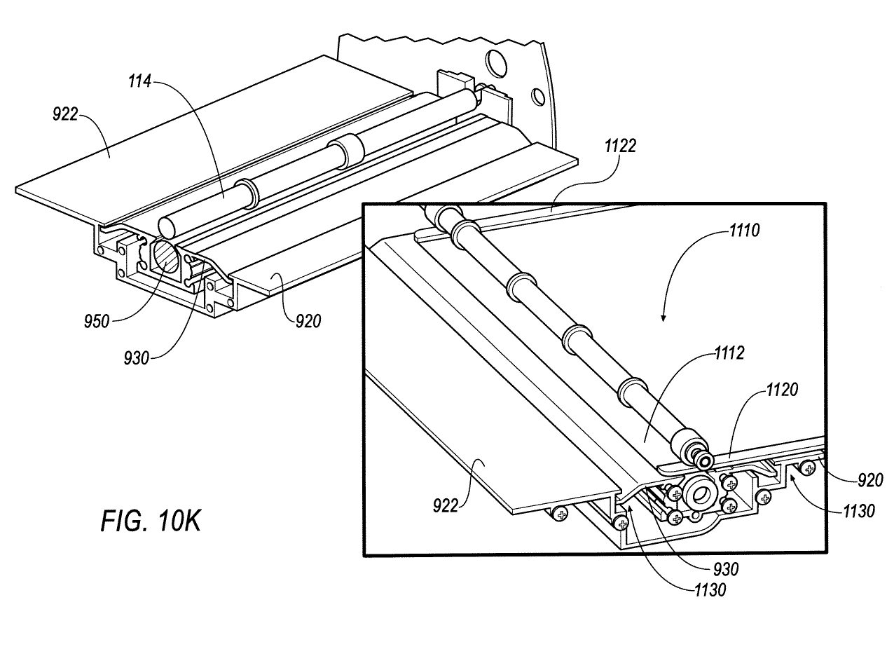

FIG. 10 is a system diagram of a combined stepper motor and DC motor driver for the cutting and printing system. DC motor 1010 is provided to move the print head 1030 in a smooth manner along a common shaft 1050. Stepper motor 1020 is provided to move the cutting head 1040 along same shaft 1050. Print head 1030 and cutting head 1040 may be commonly connected to shaft 1050, or they may be selectively engaged, for example by clutch, latch, or operation of an electromechanical actuator. By providing a DC motor drive 1010, a smooth, closed loop feedback drive system may be employed for printing that may not require significant torque, while a stepper motor drive 1020 may provide a high torque system for cutting stock. If print head 1030 and cutting head 1040 are commonly connected to shaft 1050, the DC motor implementation may still be used because the cutting torque requirements are not needed when the blade is not engaging stock.

As discussed herein, FIGS. 10A through 10K describe an alternative example for a printing and cutting mechanism. The example may include control systems from both a print mechanism and a cutting mechanism. In addition, there may be merged systems that control both printing and cutting, and in particular, the optimization and sequence of various print and cut operations.

FIGS. 10A and 10B are an example mechanism 100 for printing and cutting. The mechanism includes a carriage 140 that rides along a central frame 130 provides for movement in the X direction of a cutting mechanism (near 142) and a printing mechanism (shown below in FIG. 10C). In general, stock such as craft paper, vinyl, or other materials, is loaded into the cutting mechanism and moved in a Y direction by rollers 116, 118, provided on a roller shaft 114. A roller motor system 112 controls the roller shaft 114 to move the craft. A carriage motor system 110 provides movement to the carriage along central frame 130 to position the cutting and printing systems relative to the stock. The X and Y movement mechanisms are a positioning system allowing the work piece to be moved under the movable print and cut systems. In this way, the positioning systems allows the print system and cut system access to the usable region of the work piece.

FIG. 10C is a back view of the example of FIG. 10A showing the printing mechanism. As shown, the printing mechanism includes a Cyan print system 320, a Yellow print system 322, a Magenta print system 324, and a Black print system 326. These colors used together form a “CYMK” printing system. As part of carriage 140, riding along a central frame 130 the printing system slides laterally in the X direction along with the cutting system. As both the printing and cutting systems are provided on the same carriage 140, they are mechanically in registration with each other. A docking station 310 may be provided at one end of the mechanism 100 for cleaning and storing the ink cartridges when not in use. As shown in FIG. 10C, the print systems 320, 322, 324, 326 are configured as inkjet print systems, each having a print head associated with the ink cartridge. For example, the inkjet print system may be configured as a thermal inkjet or a piezoelectric inkjet. The inkjet heads may be configured as a fixed-head or a disposable head. Where a disposable head is used, the head may be a separate component or built into the ink tank that supplies the ink.

As discussed herein, the docking station 310 may be a multipurpose system that allows for storage and cleaning of the print heads. For example, the print head may be susceptible to contaminants and/or drying of the ink that may cause failure of certain ink jets or ink passageways (e.g., leading through the print head to the nozzle). Such drying and clogging of the print head may lead to an irregular drop pattern and/or clogging of the nozzle that prevents normal operation of the inkjet nozzle. Moreover, contaminants from the cutting system, such as loose paper or paper dust, may threaten to clog the nozzles. In these examples, the docking station may be used to clean the print head and/or apply moisture to it to prevent drying.

For example, the docking station may include a felt material or a bristle-like material to clean the print head. Moreover, when docked for long periods, the docking station 310 may provide a seal around the print heads to prevent drying. In another example, moisture may be provided (e.g., by a user) to the docking station 310 to maintain a moistened state of the print head. In another example, the docking station may provide a suction mechanism so that when the print heads are docked that air is substantially evacuated to reduce drying of ink.

FIG. 10D is a right side view of the example of FIG. 10A. Carriage motor system 110 may drive the carriage 140 (see FIG. 10A) using a belt drive system 410. Alternatively, a tensioned cable or other semi-rigid configuration may be used, for example, to achieve acceptable accuracy. As shown, the cutting system (on the left side of FIG. 10D but not shown) may be positioned opposite the print system (see 320). The positioning on opposite sides of the central carriage 140 (see FIG. 10A) provides a reduced package size (e.g., overall length) as compared with a side-by side printing and cutting system.

FIG. 10E is a left side view of the example of FIG. 10A. Roller motor system 112 may be connected to roller shaft 114 (see FIG. 10A) by a gear set 512, 520 and belt 515 system. As gear 520 is rotated, roller shaft 114 rotates, as does rollers 116, 118 to engage and move the work piece (e.g., the stock to be printed and/or cut). An end roller 530 may be used at the opposite side of the mechanism to provide tension to belt drive system 410.

A floating/movable floor (see FIGS. 10D-10E and 10I-10K) provides a system to maintain an appropriate distance of the material being printed on and the print head systems. This distance may be measured, for example, by the distance of the bottom of the print head's bottom surface (e.g., where the exit point of the nozzles are) and the upper surface of the material being printed on (e.g., the stock or work piece). The printing and cutting system may also include material handling system that provides for various thicknesses of materials to be both printed on and cut. A typical material handling system for the stock material may be used, such as a sticky-mat that holds craft paper. However, where other materials are used as stock, or where the thickness of the material is unknown, other material handling systems may be needed. The thickness of the material may be important in the printing operation, more so than the cutting operation. This is due to the design requirements of inkjet print heads. The inkjet print head is typically designed to be used at a predetermined distance, or a range of distances, from the material being printed upon. The design distance may be related, for example, to the droplet size of the ink projected from the inkjet print head. Where the material to be printed upon is too close, there may be excessive force on the ink droplet when it hits the material, causing the ink dot to become overly large and possibly splashing back to the print head causing clogging. Alternatively, when the material to be printed upon is too far away from the print head, there may not be enough force for appropriate adhesion of the ink to the material, and the ink droplet may become overly enlarged.

Each of these design problems may be solved with a floating floor under the print and cut system. The floating floor may include a floor 920 (see FIG. 10I), that allows for vertical movement relative to rollers 116, 118. Referring now to FIGS. 10D-10E, each side of the moveable floor is connected to a sliding arm 440, 440′. Each sliding arm at one end slides along a slot and a pin 450, 450′. The movable floor is biased upwardly by springs 420, 420′ to provide an upward force to press the stock against the rollers 116, 118. The movable floor may also include pistons 430, 432, and 430′, 432′ that slide vertically (see also FIG. 10G). Because each sliding arm 440, 440′ has two pistons 430, 432, and 430′, 432′, respectively, the sliding arm maintains a substantially parallel position when moved up and down. The pistons 430, 432, 430′, 432′ are generally perpendicular to the movable floor as shown. However, movable floor may be configured to be at an angle, and as such the pistons 430, 432, 430′, 432′ are generally perpendicular to the upper rollers.

The movable floor and the lower roller maintains a substantially parallel position (with respect to the upper roller) when moved up and down. In this way, various thickness materials may be used with the printing and cutting system, while still maintaining a desired distance between the stock and the print head. In general, the pistons determine the orientation of the movable floor, and also maintain the lower roller system as parallel with the upper roller system to maintain an equal distance between the upper and lower roller system along the length of the work piece. Moreover, the movable floor provides support to the work piece in operation to avoid bending or twisting of the work piece, particularly during a cutting operation.

FIG. 10F is atop view of the example of FIG. 10A. The printing mechanism (e.g., Cyan print system 320, Yellow print system 322, Magenta print system 324, and Black print system 326) are shown opposite to the cutter 210. As material is moved under the print and cut system, the controller may decide to engage the blade for cutting, or control the printing system. These steps may be performed simultaneously, or they may be staggered in time to reduce contamination to the print head or other reasons such as potential smearing of ink.

FIG. 10G is a bottom view of the example of FIG. 10A. The docking station 710 (also shown as 310 in FIG. 10C) may be attached to the bottom side of the print and cut mechanism. As discussed above, the docking station 710 may be used to clean the print heads, as well as maintain the moisture level so that drying of ink and clogging of the inkjet nozzles is reduced. Here, the pistons 430, 432, and 430′, 432′ for the movable floor are shown in an alternative view.

FIG. 10H is a perspective view of the example of FIG. 10A. Movable floor 120 may move up and down to adjust to the thickness of the stock material to be printed on and/or cut. The floor may also align with an outer door 820 that may be integrated with the housing. The outer door 820 may swing downwardly to expose the printing and cutting mechanism for use, as well as provide a stabilizing surface for the material to be cut. Also shown is a cartridge 810 that allows the user to print and out designs without requiring a computer-like device to control the print and cut system.

FIGS. 10I and 10J show a cross-sectional view of the example of FIG. 10A. The movable floor 930 is shown in cutaway as being biased upwardly (e.g., by springs 420, 420′ to engage lower roller 950 against upper roller 114. Moveable floor 930 also engages stationary floor members 920, 922 when at the uppermost position. Stationary floor members 920, 922 provide a rigid surface for the work piece/stock to rest upon while being configured by the print and cut system. In use, the springs 420, 420′ bias the work piece between upper roller 116 and lower roller 916. This biasing, and the pressure between the rollers, allows the print and cut system to move the work piece in the Y direction when in use by rotating upper roller 116. As shown, outer door 820 provides support for a work piece that may extend out of the front of the print and cut system, reducing bowing of the work piece that may be undesirable. The lower roller bar 950 and rollers may be provided in a cavity provided in movable floor 930. In this way, the lower rollers 950 are provided access to the work piece, while at the same time the movable floor maintains rigidity for a substantially parallel support surface.

FIG. 10K includes views of a roller system 1110 for engaging a mat 1112 for the example of FIG. 10A. The movable floor 930 is shown between stationary floor members 920, 922 and under upper roller bar 114. A mat 1112 may be provided to hold the work piece. The mat may be configured with a sticky surface to hold the work piece in place during printing and cutting operations, while allowing the work piece to be removed without substantial damage (e.g., tearing).

To provide for various thicknesses of work pieces (e.g., the thickness of the stock), the mat 1112 may allow for shims 1120, 1122 to be attached near the edges of the mat to determine the distance between the upper rollers and the lower rollers. This may be advantageous where, in particular, the print and cut system may not desire to engage the work piece directly to prevent smearing or marking by the rollers. The shims 1120, 1122 may be permanently attached to the mat or they may be removable. If configured as removable shims, the user may be provided with various thicknesses for shims 1120, 1122 so that different thickness work pieces may be printed upon and cut. The shims 1120, 1122 are positioned on the mat 1112 so that they run between the upper and lower rollers to provide movement to the mat 1112.

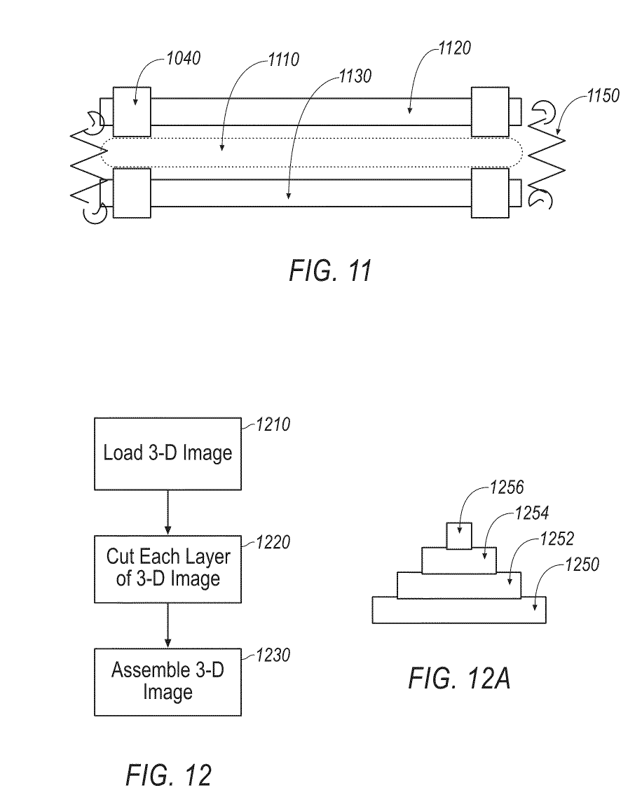

FIG. 11 is an alternative example of a floating roller system that accepts thick material stock 1110, such as foam board. Upper and lower board 1110, 1120 provide rollers 1140 to firmly grip stock 1110. Springs 1150 may be used to tension rollers 1140 toward each other to hold the stock 1110. Alternatively, a stepper motor drive or other tensioning system may be employed to provide that rollers 1140 grip stock 1110. As discussed above with respect to FIGS. 10A-10K, the floating roller system may allow for various thicknesses of material stock to be used while maintaining a predetermined distance from the print head to the surface of the material stock. This predetermined distance may be desirable because the print quality may suffer if the material stock is too close to, or too far away from, the print head. The cutting system may include a plunge-type blade that may handle various thicknesses of material without regard for the distance of the bottom of the material stock (e.g., where the blade penetrates to). However, given that a blade has a fixed length, the distance to the bottom of the material stock may be limited by the maximum distance between the rollers, effectively limiting the required plunge distance of the cutting blade.

FIG. 12 is a method for cutting three-dimensional shapes using printer/cutter 10. At step 1210, printer/cutter 10 loads a 3-D image into memory and processes each layer of the image. The 3-D image may be stored on a cartridge or a memory. At step 1220, printer/cutter 10 cuts each layer of the image from the stock, such as foam board, paper, or other material. At step 1230, the user may layer the cut image portions to construct a 3-D design. In this way, the system provides for layered construction of a design based on multiple cut pieces. Moreover, the system may scale each layer according to the user's desired size to maintain relative size among the layers.

FIG. 12A shows a layered 3-D image in cross section of a pyramid, having bottom layer 1250, and layers 1252, 1254, and top layer 1256. In this way, the user constructs the layered design. The printing system may also include assembly notes or instructions on some or all of the layered pieces. For example, the surface of each layer may include a printed indication of which is first and the sequence of assembly (e.g., 1, 2, 3) when the printed indication is appropriately hidden by layers on top of it.

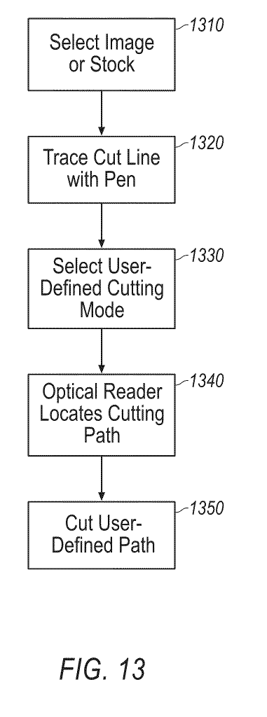

FIG. 13 is a method of user-defined cutting of a shape. At step 1310, the user may select to print an image or select blank stock. At step 1320, the user traces a cut-line on the stock using a pen (the pen's ink having properties defined below). At step, 1330, the user loads the stock to printer/cutter 10 and selects a user-defined cutting mode. At step 1340, printer/cutter 10 uses an optical reader to determine the position of the pen's ink placed on the stock. Once a line has been determined, e.g. using a search technique of the page, printer cutter 10 may cut along a path defined by the pen's ink. The cutter may follow the user-defined cut path precisely by using an optical sensor to follow the path in real-time or near real-time, or the cutting path may be pre-scanned and stored for subsequent cutting. The optical sensor system may be sensitive to certain frequencies of light, such as UV or IR, and may also be provided with an illumination source (such as a UV or IR LED). In this way, the ink of the pen may also reflect UV or IR and the optical sensor, with illuminator, may track the position of the user-defined cutting line.

Other methods for printer/cutter 10 may include image or object selection for cropping. For example, the user may import an image of a person in front of a background. An object selection algorithm can determine the objects within a image (e.g., a person, a car, a house, etc.) and the user can select which object to crop. Printer/cutter 10 can then crop the image to the object, printing only the object and cutting the object at its boundaries.

In another example, cartridge 50 may include storage of an image, a mask, and a cutting boundary, in a single file, or multiple files identified with one another. The file may include raster data for the image, as well as vector data for the cutting path.

In another example, printer/cutter 10 may include a border detection system to determine where the border for an image is, and generate a cut path along the border. If using a pixel-based image, the border detection system may include the ability to cut through the pixels to avoid white areas at the cutting boundary. In another example, printer/cutter 10 may include an optical sensor to determine the paper size. The optical sensor may detect the presence or absence of paper under it by reflection of a beam of light generated by printer/cutter 10 or by ambient light reflection. In another example , printer/cutter 10 may include a touch screen allowing the user to select images, select objects in an image, or “finger edit” an image or cutting boundary. In another example, a writable cartridge 50 may be included allowing a user to create an image and cutting boundary and save it for later use or further editing. In another example, printer/cutter 10 may include persistent storage other than cartridge 50 allowing the user to accumulate a library of images and/or cutting paths within printer/cutter 10 that may also be transferable to cartridge 50 or a computer.

In another example, printer/cutter 10 may include a peripheral interface allowing for a tablet-input by the user. The user may then “draw” the cutting boundary or make edits to the image or cutting path using the tablet. The tablet may also be used to generate a free-hand cutting path that is stored or cut in real-time. In another example, printer/cutter 10 may include the ability to suspend a printing sequence to allow the user to refill an ink cartridge and then continue with printing. In another example, printer/cutter 10 may provide for the use of textured inks. In another example, printer/cutter 10 may provide for an embossing feature. The cutting mechanism (or knife) may be replaced with an embossing head and a rigid material may be placed under the paper. Printer/cutter 10 then embosses at the cut path rather than cutting through the stock material. Alternatively, the embossing path may be displaced from the cutting path. In another example, printer/cutter 10 may include paper spooling ability, where a mat is not used and a spool or roll of backed paper allows for the production of banners.

The present invention has been described with reference to certain exemplary embodiments thereof. However, it will be readily apparent to those skilled in the art that it is possible to embody the invention in specific forms other than those of the exemplary embodiments described above. This may be done without departing from the spirit of the invention. The exemplary embodiments are merely illustrative and should not be considered restrictive in any way. The scope of the invention is defined by the appended claims and their equivalents, rather than by the preceding description.

What is claimed is:

1. A system, comprising:
a housing;
a printing system connected to said housing, said printing system having a print head, said print head having a bottom surface;
a cutting system connected to said housing;
a movable floor connected to said housing, wherein said movable floor adjusts to the thickness of a stock to be printed, said movable floor providing a predetermined distance from said bottom surface of said print head and an upper surface of said stock.

2. The system of claim 1, further comprising:
a positioning system for said printing system and said cutting system.

3. The system of claim 2, wherein said printing system and said cutting system are in mechanical registration with each other.

4. The system of claim 2, wherein said positioning system includes an upper roller and a lower roller;

5. The system of claim 4, wherein said lower roller is biased against said upper roller.

6. The system of claim 5, wherein said biasing is provided by at least one resilient element.

7. The system of claim 2, wherein said movable floor provides support to said stock during printing.

8. The system of claim 2, wherein said movable floor further comprises:
at least one sliding arm.

9. The system of claim 2, wherein said movable floor further comprises:
at least two pistons oriented substantially perpendicular to the movable floor, wherein said pistons determine the orientation of said movable floor when moving.

10. A method, comprising:
receiving an image having a boundary;
determining a border thickness;
applying a border at said thickness to said boundary; and
cutting said image from a sheet material within said border.

11. The method of claim 10, wherein the step of determining a border thickness comprises:
receiving a thickness input from a user.

12. The method of claim 10, wherein the step of determining a border thickness comprises:
extending said boundary outwardly a predetermined distance.

13. The method of claim 8, wherein the step of determining a border thickness comprises:
scaling said border.
